(19) United States
(12) Patent Application Publication
(10) Pub. No.: US 2022/0205259 A1
(43) Pub. Date: Jun. 30, 2022

(54) PLASTIC FORMWORK AND MANUFACTURING METHOD THEREOF

(71) Applicant: Yu-Tsai Wu, New Taipei City (TW)

(72) Inventor: Yu-Tsai Wu, New Taipei City (TW)

(21) Appl. No.: 17/137,318

(22) Filed: Dec. 29, 2020

(51) Int. Cl. E04G 9/10; E04G 11/12

(52) U.S. Cl. CPC E04G 9/10; E04G 2009/023; E04G 11/12

(57) ABSTRACT

The plastic formwork includes a main member made of polypropylene, stone powder, flame retardant, and reinforcing agent mixed together, where the main member has a number of channels inside and the channels are sealed by caps. To produce the plastic formwork, polypropylene, stone powder, flame retardant, and reinforcing agent are stirred, heated, and melted together, and the mixture is driven through a mesh forming machine to produce the main member. Finally, caps are attached to the main member to seal the channels. The manufacturing process allows convenient, precise, and uniform addition of materials, thereby improving production efficiency and product stability. The formwork provides fire retardation, heat isolation, sound proof, water tightness, and reusability. Additionally, cement paste is prevented from flowing into the main member, thereby avoiding the breeding of bugs and molds.

### BACKGROUND OF THE INVENTION

### (a) Technical Field of the Invention

The present invention is generally related to formworks, and more particular to a plastic formwork and its manufacturing method.

### (b) Description of the Prior Art

In the context of concrete construction, formworks are often used to provide temporary or permanent molds into which concrete or similar materials are poured so as to form concrete walls and columns.

Based on the material used, there are timber, metal, and plastic formworks. Timber formworks may absorb water and often have rough surfaces. Therefore, an additional leveling process is usually required after using timber formworks. Timber formworks are also hard to recycle and need to be handled as waste afterwards. Timber formworks, as such, are costly and not environmentally friendly. Metal forworks are heavier and more difficult to move and process. They are more appropriate for spacious construction sites or sites with handling capability. Plastic formworks, lacking the above shortcomings, are more popular these days.

Conventional plastic formworks, however, still suffer the following disadvantages.

First, the manufacturing of the conventional plastic formworks is not convenient to add multiple materials.

Second, the manufacturing of the conventional plastic formworks usually relies on a single stirring device and cannot mix multiple materials uniformly.

Third, cement paste may flow into the hollow interior of a conventional plastic formwork, thereby increasing its weight and causing blockage.

Fourth, if water is splashed inside a conventional plastic formwork, molds or bugs such as ants and termites may breed in the plastic formwork after a period of time.

Fifth, when cement paste is poured inside the mold formed by plastic formwork, the plastic formworks may expand or contract due the cement paste's temperature, thereby leading to deformation to the concrete work.

### SUMMARY OF THE INVENTION

A first objective of the present invention is to prevent cement paste from flowing into a plastic formwork and, as such, to prevent bugs and molds from breeding by using caps to seal the plastic formwork.

A second objective of the present invention is to maintain the stability of molds formed by plastic formworks by having channels with openings inside the plastic formworks.

A third objective of the present invention is to achieve fire retardation, heat isolation, sound proof, water tightness, and reusability in a plastic formwork by mixing polypropylene, stone powder, flame retardant, and reinforcing agent in the plastic formwork.

A fourth objective of the present invention is to apply three screw mixers in the manufacturing of plastic formworks so that the raw materials may be added conveniently, uniformly, and precisely.

The plastic formwork according to the present invention includes a main member made of polypropylene, stone powder, flame retardant, and reinforcing agent mixed together, where the main member has a first side and a second side opposite the first side. A number of channels are provided inside the main member extending from the first side to the second side, where each channel has openings respectively on the first and second sides, making the main member mesh-like. A number of caps are attached to the first and second sides, thereby sealing the openings on the first and second side.

The plastic formwork is manufactured as follows: stirring, heating, and melting polypropylene in a first screw mixer; stirring, heating, and melting stone powder in a second screw mixer; combining and mixing the polypropylene from the first screw mixer and the stone powder from the second screw mixer in a third screw mixer; and adding and mixing flame retardant and reinforcing agent in the third screw mixer through a solvent feeding device, thereby forming a mixture.

The manufacturing method further includes: placing the mixture from the third screw mixer in a mesh forming machine; cooling and setting the mixture out of the mesh forming machine by a cooling device, thereby producing a main member of the plastic formwork. Finally, a cap is attached to each of the two sides of the main member, thereby sealing the channels.

In this way, raw materials may be added in forming the plastic formworks conveniently, uniformly, and precisely. The molds framed by the plastic formworks are stable. Cement paste is prevented from flowing into the plastic formworks, thereby preventing bugs and molds from breeding.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a main member of a plastic formwork according to a first embodiment of the present invention.

FIG. 2 is a perspective break-down diagram showing a plastic formwork according to a first embodiment of the present invention.

FIG. 3 is a block diagram showing the plastic formwork of FIG. 2.

FIG. 4 is a flow diagram showing a manufacturing method of the plastic formwork of FIG. 2.

FIG. 5 is a perspective diagram showing a manufacturing environment of the plastic formwork of FIG. 2.

FIG. 6 is a perspective diagram showing a step of manufacturing the plastic formwork of FIG. 2.

FIG. 7 is a perspective diagram showing another step of manufacturing the plastic formwork of FIG. 2.

FIG. 8 is a perspective diagram showing yet another step of manufacturing the plastic formwork of FIG. 2.

FIG. 9 is a perspective diagram showing the main member of FIG. 1 whose sides are sealed by caps.

FIG. 10 is a perspective diagram showing the main member of FIG. 1 used as roof.

FIG. 11 is a perspective diagram showing the main member of FIG. 1 applied as a bed board.

FIG. 12 is a perspective diagram showing a plastic formwork according to a second embodiment of the present invention.

FIG. 13 is a perspective diagram showing a plastic formwork according to a third embodiment of the present invention.

FIG. 14 is a perspective diagram showing a plastic formwork according to a fourth embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

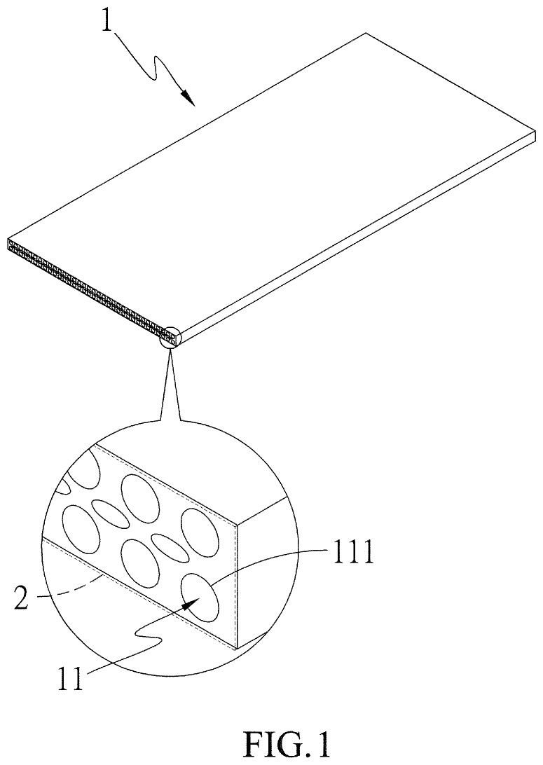

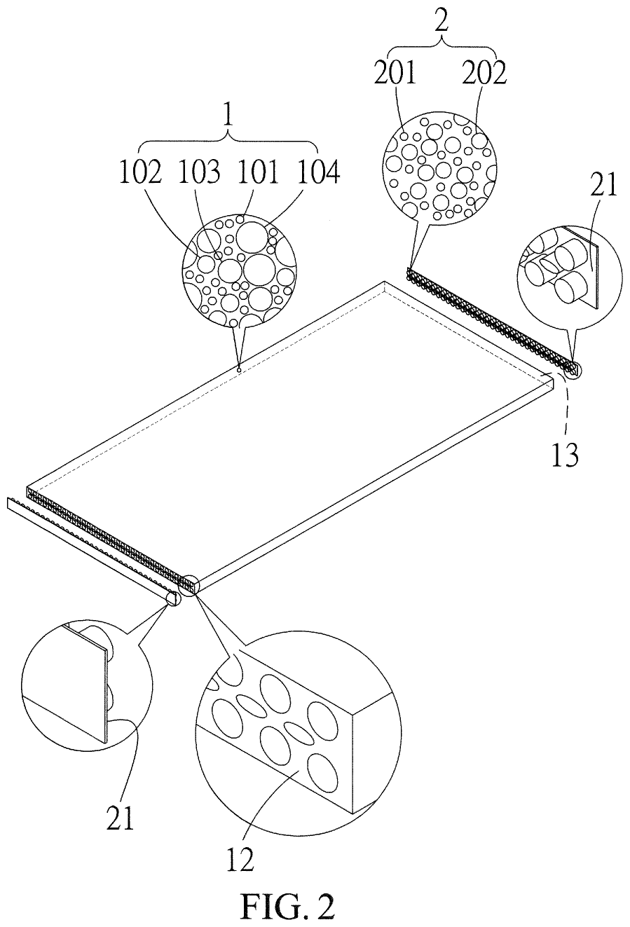

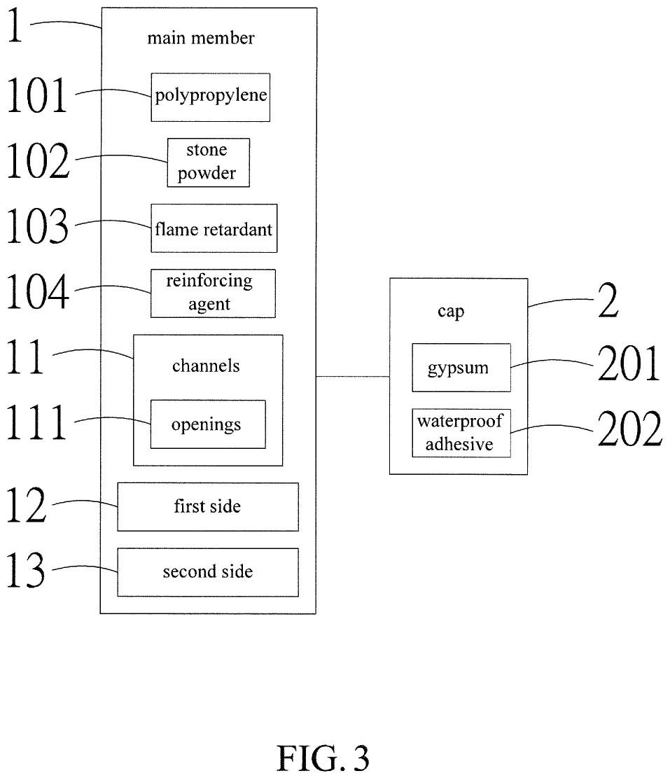

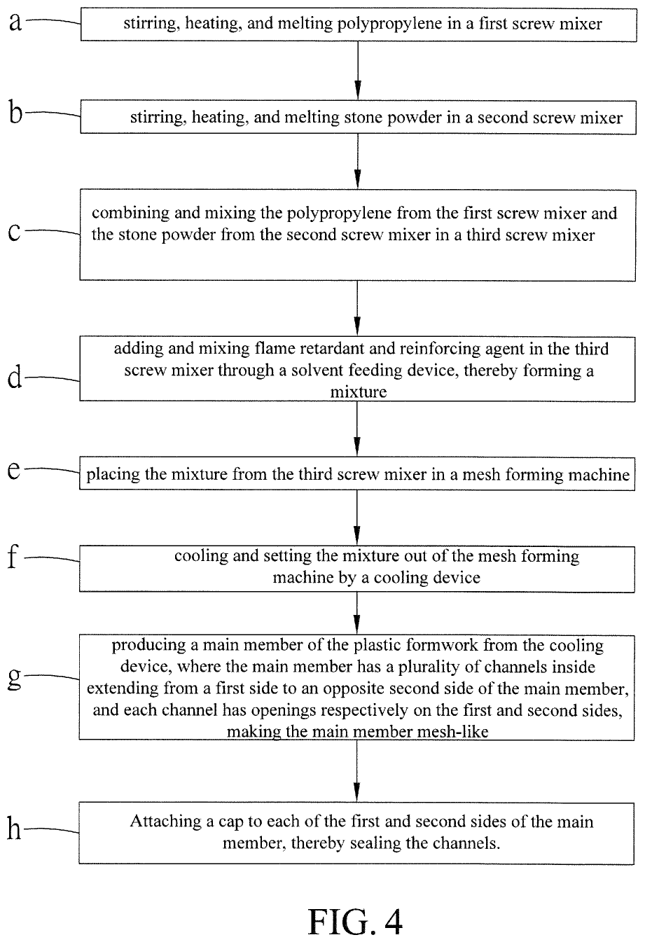

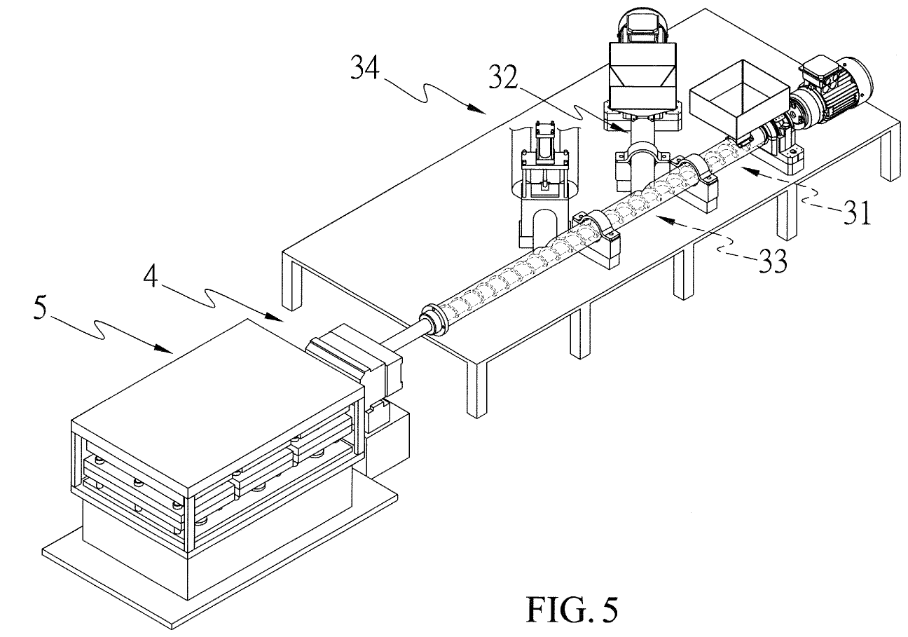

As shown in FIGS. 1 to 11, a plastic formwork according to a first embodiment of the present invention includes:

A main member 1 made of polypropylene 101, stone powder 102, flame retardant 103, and reinforcing agent 104 mixed together, where the main member 1 has a first side 12 and a second side 13 opposite the first side;

A number of channels 11 inside the main member 1 extending from the first side 12 to the second side 13, where each channel 11 has openings 111 respectively on the first and second sides 12 and 13, making the main member 1 mesh-like; and

A number of caps 2, each having an inner side 21 and each respectively having its inner side 21 attached to the first and second sides 12, thereby sealing the openings 111 on the first and second side 12 and 13.

The cap 2 is made of gypsum 201 and waterproof adhesive 202.

Preferably, the flame retardant 103 is made of organic halogen material, organic phosphorus material, or inorganic material.

Preferably, the channels 11 and their openings 111 are arranged so that the first and second sides 12 and 13 appear honeycombed.

Preferably, each opening 111 may have a square, rectangular, polygonal, or circular shape, where the present embodiment adopts circular openings 111.

Preferably, the main member 1 has a flat rectangular body.

Preferably, the main member 1's sides may have smooth or textured surface, where the present embodiment adopts smooth surface.

Preferably, each cap 2 is formed by plastering on the first and second sides 12 and 13 of the main member 1.

A manufacturing method for the plastic formwork according to the present invention includes the following steps:

(a) stirring, heating, and melting polypropylene in a first screw mixer;

(b) stirring, heating, and melting stone powder in a second screw mixer;

(c) combining and mixing the polypropylene from the first screw mixer and the stone powder from the second screw mixer in a third screw mixer;

(d) adding and mixing flame retardant and reinforcing agent in the third screw mixer through a solvent feeding device, thereby forming a mixture;

(e) placing the mixture from the third screw mixer in a mesh forming machine;

(f) cooling and setting the mixture out of the mesh forming machine by a cooling device;

(g) producing a main member of the plastic formwork from the cooling device, where the main member has a number of channels inside extending from a side to an opposite side, and each channel has openings respectively on the two sides, making the main member mesh-like; and

(h) Attaching a cap to each of the two sides of the main member, thereby sealing the channels.

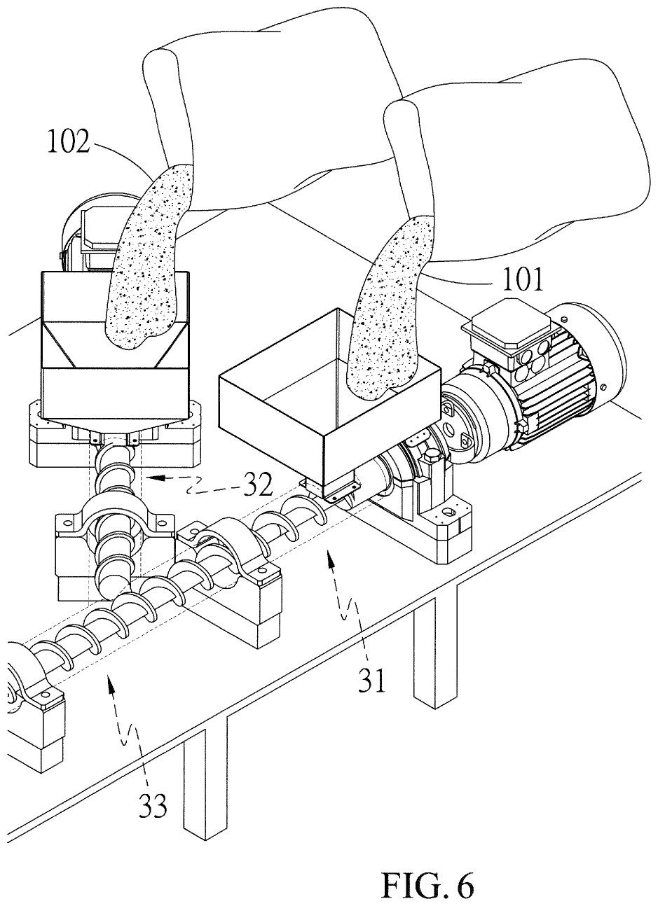

As described above, polypropylene 101 is placed in the first screw mixer 31, while the stone powder 102 is placed in the second screw mixer 32, where they are respectively stirred, heated, and melted as shown in FIG. 6. As illustrated, the first screw mixer 31 and the second screw mixer 32 have their respective screws arranged to have an included angle in between. The stirred and melted polypropylene 101 and stone powder 102 are fed to the third screw mixer 33. The polypropylene 101 and stone powder 102 are then mixed by the third screw mixer 33, where they are further heated and stirred so that the polypropylene 101 and the stone powder 102 are uniformly blended.

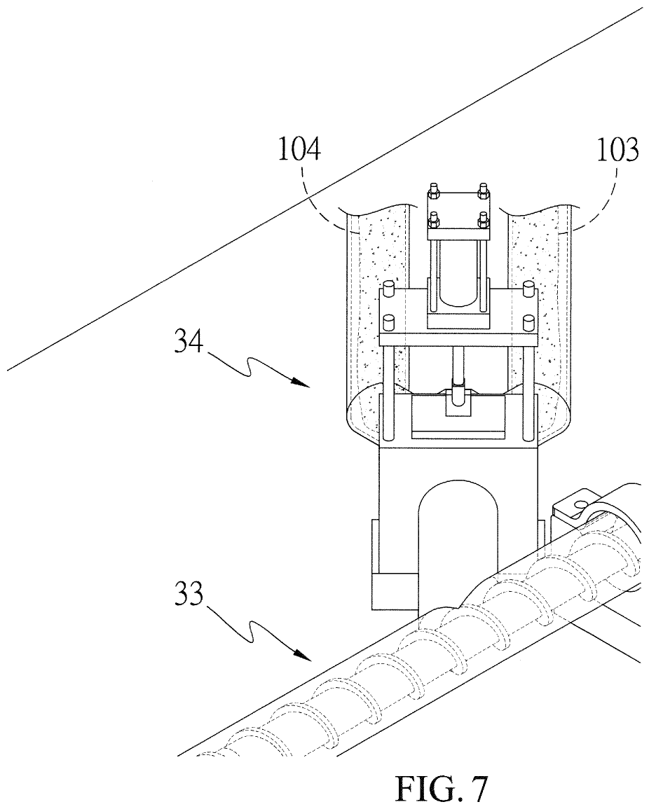

Then, as shown in FIG. 7, flame retardant 103 and reinforcing agent 104 are introduced into the third screw mixed 33 by the solvent feeding device 34. In the present embodiment, the solvent feeding device 34 is a hydraulic device, and the solvent feeding device 34 delivers the flame retardant 103 and the reinforcing agent 104 into the third screw mixer through hydraulic means. The flame retardant 103 and the reinforcing agent 104 then mix with the polypropylene 101 and the stone powder 102 in the third screw mixer 33, where they are jointly stirred and heated into the mixture.

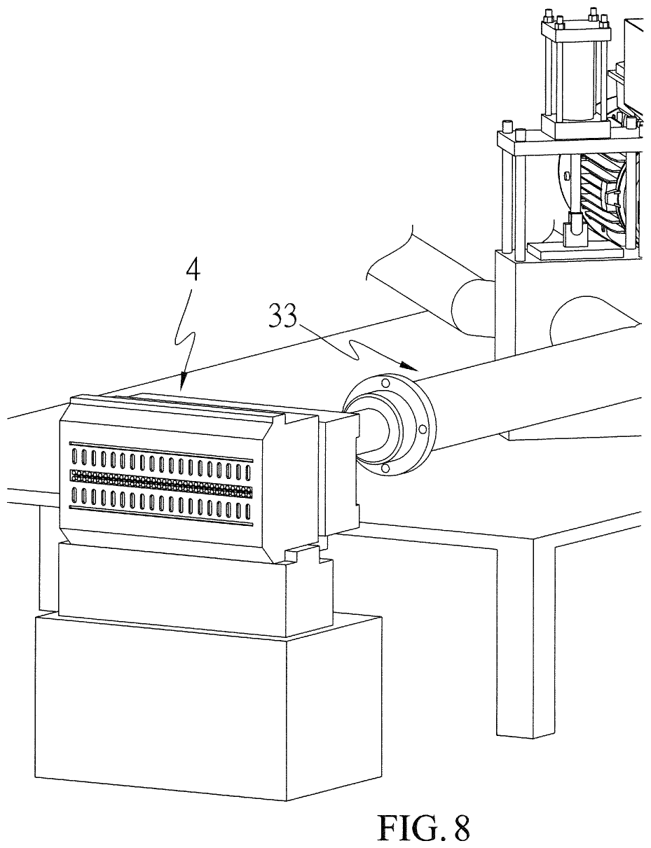

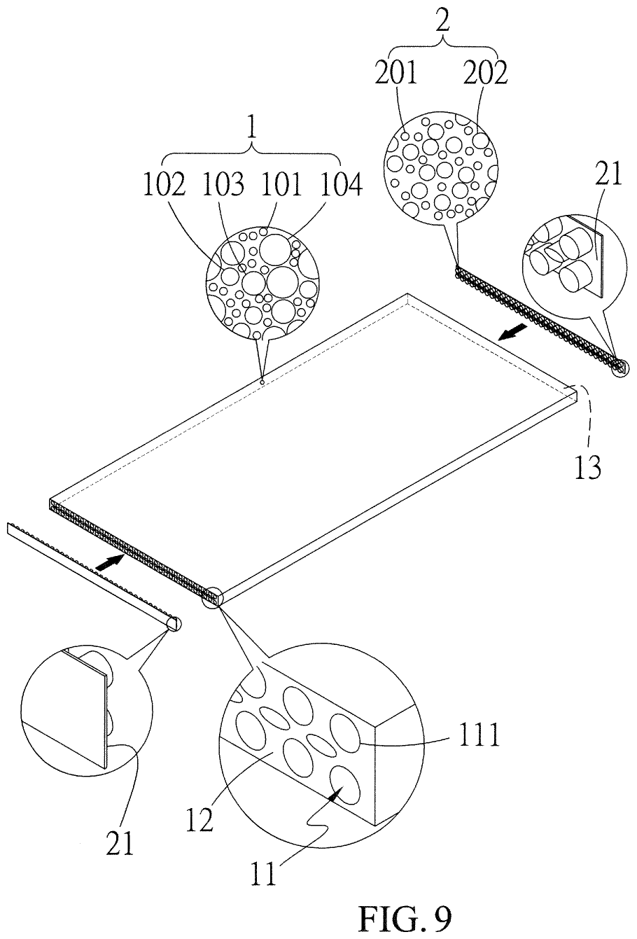

The mixture is then fed into the mesh forming machine 4 from the third screw mixer 33, where the mixture is extruded and formed as shown in FIG. 8. The extruded and formed mixture is cooled and set in the cooling device 5 into the main member 1 of the present invention. Through the design of the mesh forming machine 4, the channels 11 of the main member 1 are formed. Finally, caps 2 are joined to the main member 1 by attaching the inner sides 21 with the first side 12 and the second side 13, respectively, as shown in FIG. 9, to seal the openings 111.

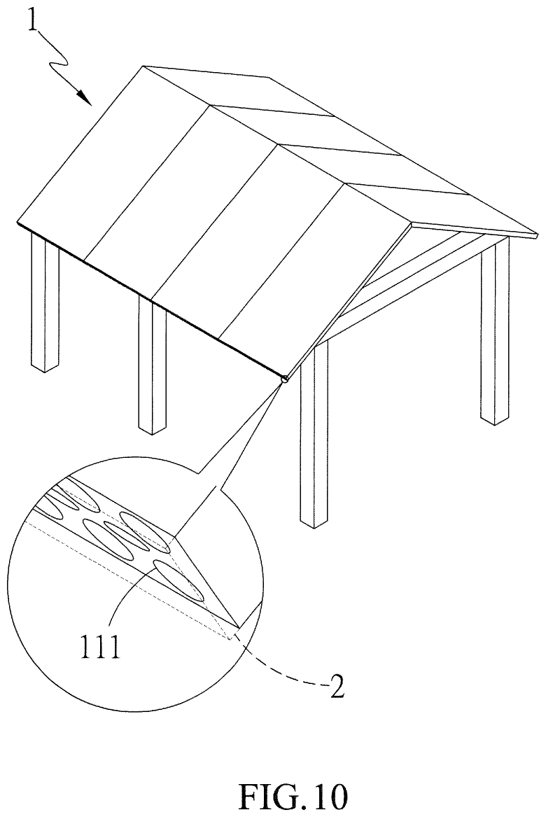

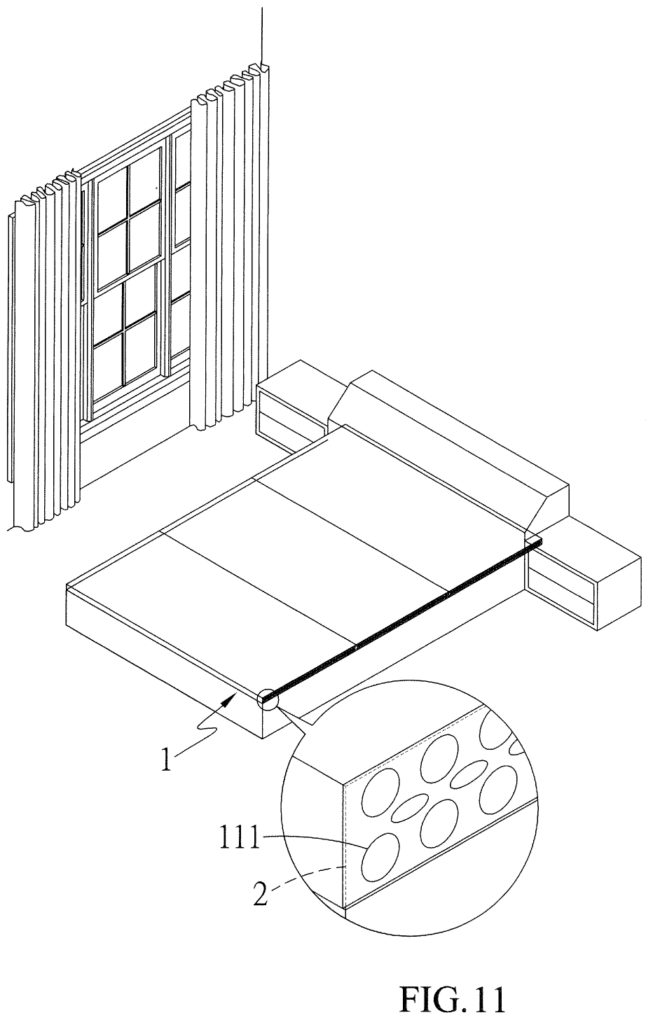

The plastic formwork not only can be applied to building construction in a conventional manner, but also can be used as roof as shown in FIG. 10 or as shown in FIG. 11. As the plastic formwork includes polypropylene 101, stone powder 102, flame retardant 103, and reinforcing agent 104, it has a level of flexibility and may be bended to a degree. A number of the plastic formworks may be adhered together through PP adhesive and used as roof. If carbamide adhesive is further sprayed on the surfaces of the plastic formwork, it then becomes rigid and nondeformable, making the plastic formworks a low-cost, durable, and green roof. Similarly, the use of the plastic formwork as bed board is also environmentally friendly. What is shown in FIGS. 10 and 11 is exemplary only and the present invention is not limited as such. Due to the flame retardant 103, the plastic formwork may also be used as partition wall in interior design, which may achieve fire retardation when there is an outbreak of fire. On the other hand, the polypropylene 101 and the stone powder 102 make the plastic formwork also waterproof.

Through the above structure, the plastic formwork not only preserves the advantages of conventional formworks, but also provides advantages such as fire retardation, heat isolation, sound proof, water tightness, reusability, and enhanced structural strength. Additionally, cement paste is prevented from flowing into the main member 1, thereby avoiding the breeding of bugs and molds. Further, the manufacturing process allows convenient, precise, and uniform addition of materials, thereby improving production efficiency and product stability. The overall water tightness of the plastic formwork is significantly increased due to the use of the caps 2 and the use of gypsum 201 and waterproof adhesive 202 in making the caps.

Furthermore, the polypropylene 101, as the main ingredient for the main member 1, ensures that nails may be driven through the main member 1 without causing the main member 1 to break up.

Furthermore, the flame retardant 103 makes the main member 1 less responsive to fire and may slow the development of fire, thereby resolving the problem that polymer materials are susceptible to fire.

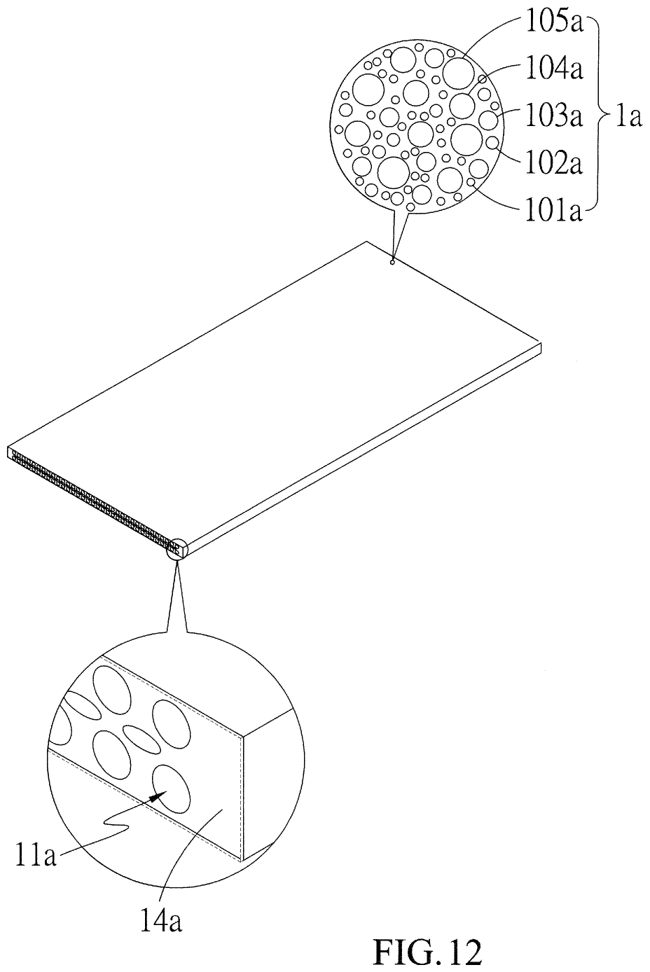

As shown in FIG. 12, a plastic formwork according to a second embodiment of the present invention has stabilizing agent 105a included in the main member 1a and reinforcing pieces 14a provided respectively on the first and second sides of the main member 1a.

The reinforcing pieces 14a are for increasing the thickness of the main member 1a's first and second sides.

The main member 1a's added stabilizing agent 105a enhances the bonding strength between the polypropylene 101a, stone powder 102a, flame retardant 103a, and reinforcing agent 104a, making the mixture more stable and viscous.

When the construction work is finished, the main members 1a may be damaged at the corners as the plastic formworks are dismantled and dropped on the ground. Through the reinforcing pieces 14a to increase structural strength, the plastic formworks may withstand greater impact without damaging the channels 11a.

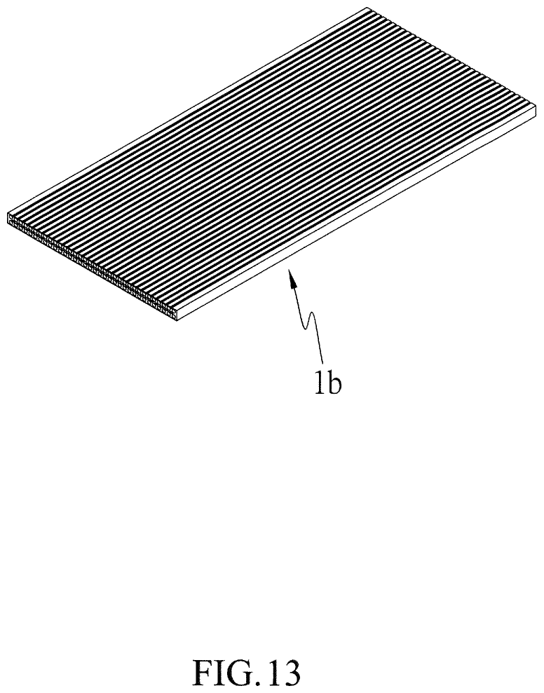

As shown in FIG. 13, a plastic formwork according to a third embodiment of the present invention has a main member 1b with textured surfaces, and the main member 1b does not have the caps.

As the plastic formwork is applied to construction, concrete plastered on the main member 1b would also appear textualized, facilitating the subsequent attachment of tiles.

When the plastic formwork is utilized in a dry and well-ventilated site, the caps are not required, thereby lowering the production cost and time.

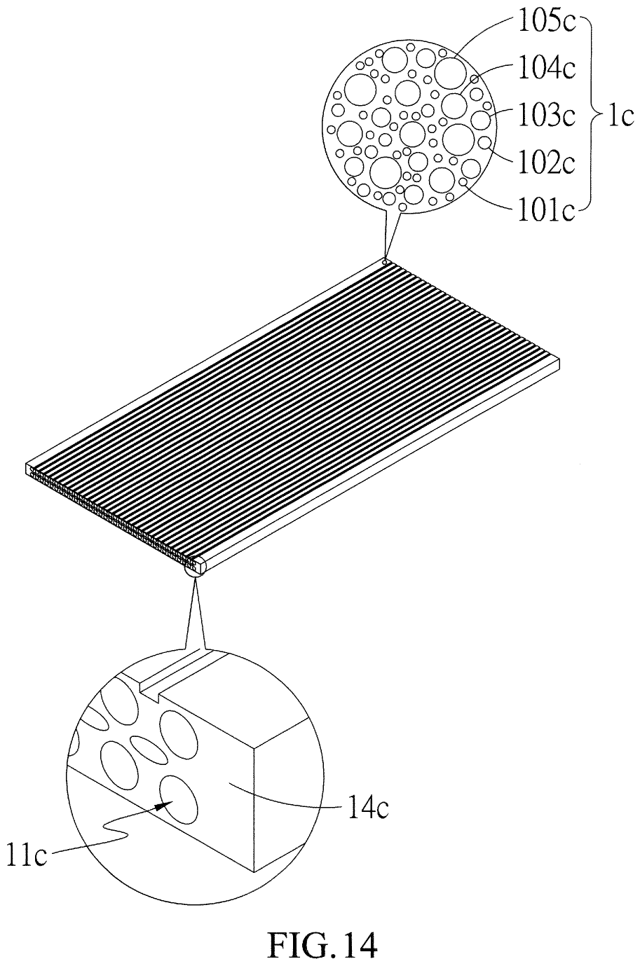

As shown in FIG. 14, a plastic formwork according to a fourth embodiment of the present invention has stabilizing agent 105c included in the main member 1c, and the main member 1c has reinforcing pieces 14c arranged along the first and second sides.

As mentioned earlier, the main member 1c's added stabilizing agent 105c enhances the bonding strength between the polypropylene 101c, stone powder 102c, flame retardant 103c, and reinforcing agent 104c, making the mixture more stable and viscous. Through the reinforcing pieces 14c to increase structural strength, the plastic formworks may withstand greater impact without damaging the channels 11c.

Therefore, as described above, the plastic formwork of the present embodiment may simultaneously achieve low cost, short manufacturing time, and enhanced structural strength.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A plastic formwork, comprising:
a main member made of polypropylene, stone powder, flame retardant, and reinforcing agent mixed together, where the main member has a first side and a second side opposite the first side;
a plurality of channels inside the main member extending from the first side to the second side, where each channel has openings respectively on the first and second sides, making the main member mesh-like; and
a plurality of caps, each respectively attached to the first and second sides, thereby sealing the openings on the first and second side.

2. The plastic formwork according to claim 1, wherein the main member further comprises stabilizing agent.

3. The plastic formwork according to claim 1, wherein each cap has an inner side attached to the first side or the second side of the main member.

4. The plastic formwork according to claim 1, wherein each cap comprises gypsum and waterproof adhesive.

5. The plastic formwork according to claim 1, further comprising at least a reinforcing piece attached to the first or second side of the main member.

6. A plastic formwork, comprising:
a main member made of polypropylene, stone powder, flame retardant, and reinforcing agent mixed together, where the main member has a first side and a second side opposite the first side; and
a plurality of channels inside the main member extending from the first side to the second side, where each channel has openings respectively on the first and second sides, making the main member mesh-like.

7. The plastic formwork according to claim 6, wherein the main member further comprises stabilizing agent.

8. The plastic formwork according to claim 6, further comprising at least a reinforcing piece attached to the first or second side of the main member.

9. A method for manufacturing a plastic formwork, comprising
(a) stirring, heating, and melting polypropylene in a first screw mixer;
(b) stirring, heating, and melting stone powder in a second screw mixer;
(c) combining and mixing the polypropylene from the first screw mixer and the stone powder from the second screw mixer in a third screw mixer;
(d) adding and mixing flame retardant and reinforcing agent in the third screw mixer through a solvent feeding device, thereby forming a mixture;
(e) placing the mixture from the third screw mixer in a mesh forming machine;
(f) cooling and setting the mixture out of the mesh forming machine by a cooling device;
(g) producing a main member of the plastic formwork from the cooling device, where the main member has a plurality of channels inside extending from a first side to an opposite second side of the main member, and each channel has openings respectively on the first and second sides, making the main member mesh-like; and
(h) Attaching a cap to each of the first and second sides of the main member, thereby sealing the channels.

10. The method according to claim 9, wherein the main member further comprises stabilizing agent.

11. The method according to claim 9, wherein each cap has an inner side attached to the first side or the second side of the main member.

12. The method according to claim 9, wherein each cap comprises gypsum and waterproof adhesive.

13. The method according to claim 9, further comprising attaching at least a reinforcing piece to the first side or the second side of the main member.
